(19) United States
(12) Patent Application Publication
(10) Pub. No.: US 2002/0063731 A1
(43) Pub. Date: May 30, 2002

(54) Method and system for offering commemorative image on viewing of moving images

(75) Inventors: Kiichiro Sakamoto, Kanagawa (JP); Hiroyasu Yamamoto, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 09/991,902

(22) Filed: Nov. 26, 2001

(30) Foreign Application Priority Data
Nov. 24, 2000 (JP) 2000-357390

(51) Int. Cl. G09G 5/00

(52) U.S. Cl. 345/723; 725/1

(57) ABSTRACT

The method and system offer a commemorative image on viewing of moving images. The method and system allow a customer who is viewing moving images to designate an image of a desired scene out of the moving images and also allowing the customer to place an order for the image of the thus designated scene as accompanied by orderer information which specifies the customer, pick up first digital image data from video signals for the moving images in response to the designation of the desired scene, the first digital image data corresponding to the image of the designated scene, create the commemorative image, using the picked-up first digital image data, that is commemorative on the viewing of the moving images and reproduces the image of the designated scene and deliver the created commemorative image to the customer after checking it against the orderer information.

### BACKGROUND OF THE INVENTION

This invention relates to a method and a system by which those scenes in moving images such as on video or TV which are desired by a viewer are offered to the viewer as commemorative images on the viewing of the moving images by being output to a specified print or a specified recording medium and the like or distributed via a communication network.

In commemoration of the viewing of motion pictures by their customers, most of the movie theaters in the world have cards available that show highlight scenes out of the picture or movie star's portraits or offer leaflets that contain a plurality of scenes out of the picture together with its synopsis and descriptive comments.

When an individual person is viewing video or the like at home, he or she may like a particular scene and want its image. Video printers capable of outputting a print showing the scene as a still image have already been developed.

For instance, JP 64-11483A discloses a video printer that picks up a frame from a video image each time a scene change occurs and by so doing, a principal scene is picked up automatically for print preparation.

JP 6-253253A discloses a video printer that prepares a desired print by capturing the image in response to a frame change as the playback signal from VTR is being displayed on the monitor.

However, the cards available at movie theaters to show highlight scenes out of a picture and movie stars' portraits or leaflets of the movies they are presenting have had the problem that the photographs do not always coincide with the pictures or scenes the customer really wants.

The video printers disclosed in JP 64-11483A and JP 6-253253A are solely for home use in which an individual person outputs prints as he or she is reproducing a video. No system exists that can be used in movie theaters and other places where many people are simultaneously viewing the same moving image and which enables offering photographic prints of a particular scene out of the movie being presented in response to the request (order) of each customer.

As another problem, those video printers use only photographic prints as output medium and on account of their low resolution, no high-quality prints can be output. Furthermore, no special services have yet been offered such as publishing a collection of prints of scenes out of moving images or compiling a collection of short moving images by selecting some moving images for one particular action and outputting them to a recording medium such as CD-R.

### SUMMARY OF THE INVENTION

The present invention has been accomplished under these circumstances and has as an object providing a method and a system by which the images of scenes chosen by a customer as he or she is viewing a motion picture, video or TV program are offered to the viewer as commemorative images on the viewing of the moving images by being output as a print or prints, an album or a collection of short moving images, or being output as a specified recording medium or media having the relevant image data recorded thereto, or by distributing said relevant image data over a network.

According to its first aspect, the present invention attains the above-stated object by providing a method of offering a commemorative image on viewing of moving images, comprising the steps of: allowing a customer who is viewing moving images to designate an image of a desired scene out of the moving images and also allowing the customer to place an order for the image of the thus designated scene as accompanied by orderer information which specifies the customer; picking up first digital image data from video signals for the moving images in response to the designation of the desired scene, the first digital image data corresponding to the image of the designated scene; creating the commemorative image, using the picked-up first digital image data, that is commemorative or the viewing of the moving images and reproduces the image of the designated scene; and delivering the created commemorative image to the customer after checking it against the orderer information.

It is preferable that the offering method further comprises the steps of: storing in a specified memory the first digital image data as picked up from the video signals for the moving images; and reading the stored first digital image data out of the specified memory, the commemorative image being created using the first digital image data as read out of the specified memory.

Preferably, the commemorative image is created as second digital image data from the first digital image data, and output as a print or prints of the moving images that reproduces the commemorative image from the second digital image data or output as a recording medium or media having the second digital image data recorded thereto or created as distribution data from the second digital image data which is to be distributed via a communication network.

Preferably, the delivery of the commemorative image takes form of delivering the output print or prints of the moving images or the output recording medium or media to the customer or distributing the distribution data to the customer via the communication network.

Preferably, the commemorative image is delivered to the customer in accordance with an image delivery method designated by the customer.

Preferably, image delivery information that designates the image delivery method is sent with the orderer information when the order for the image of the designated scene is placed by the customer.

Preferably, the commemorative image is created as a collection of images of a plurality of designated scenes.

Preferably, the collection is an album prepared in a specified format using a plurality of prints of moving images that reproduce the plurality of designated scenes.

Preferably, the first digital image data which is picked up from the video signals for the moving images in response to the designation of the desired scene when the order for the image has been placed is the first digital image data for a plurality of successive images in one action which corresponds to the designated scene, second digital image data for the one action is created as the commemorative image from the first digital image data for one action, and the second digital image data for the one action is recorded to a specified recording medium as the commemorative image.

Preferably, the first digital image data is composited with an image already prepared by the customer to create the commemorative image.

Preferably, the first digital image data for images of designated scenes by the customer are stored in the memory, the first digital image data are read out of the memory and displayed on a monitor, and the image of the designated scene by the customer, for which the order is finally to be placed by the customer is chosen from the thus displayed images of designated scenes by the customer on the monitor.

Preferably, the first digital image data for the images of scenes within a specified time range including not only the image of the designated scene out of the moving images which has been designated by the customer but also images both before and after the image are stored in the memory, the first digital image data are displayed on a monitor, and the image of the designated scene by the customer, for which the order is finally to be placed by the customer is designated from the thus displayed images of the scenes within the specified time range on the monitor.

Preferably, the first digital image data corresponding to images of a plurality of specified scenes within the moving images are preliminarily stored and when the order for the image of the designated scene is placed, the first digital image data for the image of a scene which is the closest to the image of the designated scene is picked up from the preliminarily stored first digital image data in response to the designation of the desired scene.

Preferably, statistics is taken of frequency of the designation of the desired scene and prior to designation of the desired scene by the customer, a commemorative image is made available for each of the images of frequently designated scenes.

Preferably, a biological reaction occurring in the customer is utilized to designate the image of the desired scene.

Preferably, the biological reaction is at least one parameter selected from among heartbeat, breathing, body temperature, brain waves and movement and attitude of eyeballs of the customer.

According to its second aspect, the present invention attains the stated object by providing a system for offering a commemorative image on viewing of moving images, comprising: a scene designating device by means of which a customer who is viewing moving images designates an image of a desired scene out of the moving images; an image ordering device by means of which the customer places an order for creation of the image of the designated scene with scene designating information which identifies the image of the designated scene and orderer information which specifies the customer; a digital image data pick-up device for picking up first digital image data from the video signals for the moving images in response to the scene designation, the first digital image data corresponding to the image of the designated scene; an image output device which, using the first digital data as picked up by the digital image data pick-up device, creates a commemorative image that is commemorative on the viewing of the moving images and reproduces the image of the designated scene and outputs the commemorative image; and an image delivery device which delivers the output

commemorative image to the customer after checking it against the orderer information.

It is preferable that the offering system further comprises a memory for storing the first digital image data as picked up by the digital image data pick-up device, wherein the image output device creates the commemorative image using the first digital image data as read out of the memory.

Preferably, the image output device creates the commemorative image as second digital image data from the first digital image data, and it is at least one device selected from among a print output device which outputs a print or prints of the moving images that reproduces the commemorative image from the second digital image data, a recording medium output device which outputs a recording medium or media having the second digital image data recorded thereto, and an image distributing device which creates distribution data from the second digital image data and distributes it via a communication network.

Preferably, the image delivery device is such that the print or prints of the moving images as output from the print output device or the recording medium or media as output from the recording medium output device is delivered to the customer as the commemorative image or the distribution data is distributed to the customer via the communication network by means of the image distributing device.

Preferably, the image delivery device delivers the commemorative image to the customer in accordance with an image delivery method designated by the customer.

Preferably, image delivery information that designates the image delivery method is sent with the orderer information when the order for the image of the designated scene is placed by the customer.

Preferably, the image output device creates the commemorative image as a collection of images of a plurality of designated scenes.

Preferably, the digital image data pick-up device picks up the first digital image data for a plurality of successive images in one action which corresponds to the designated scene and stores the picked-up first digital image data in the memory, and the image output device creates as the commemorative image second digital image data from the first digital image data for the one action which has been stored in the memory and outputs the second digital image data for a one action to a specified recording medium.

It is also preferable that the offering system further comprises: an image input device for entering an image already prepared by the customer; and an image compositing device by means of which the image entered by the image input device is composited with the first digital image data, wherein a composite image created by the image compositing device is output from the image output device as the commemorative image.

It is further preferable that the offering system further comprises: a monitor by means of which the first digital image data as stored in the memory which correspond to images of designated scenes by the customer are read out of the memory and displayed; and a scene selecting device by means of which the image of the designated scene by customer, for which the order is finally to be placed by the customer is chosen from the thus displayed images of the designated scenes by customer on the monitor.

Preferably, the digital image data pick-up device picks up the first digital image data for the images of scenes within a specified time range including not only the image of the designated scene out of the moving images which has been designated by the customer but also images both before and after the image and stores the first digital image data in the memory, the first digital image data are displayed on the monitor, and the image of the designated scene by the customer, for which the order is finally to be placed by the customer is designated by the scene selecting device from the thus displayed images of the scenes within the specified time range on the monitor.

It is another preferable that the offering system further comprises a data base for preliminarily storing the first digital image data corresponding to images of a plurality of specified scenes within the moving images, wherein the digital image data pick-up device picks up from the data base the first digital image data for the image of a scene which is the closest to the image of the designated scene by the customer.

Preferably, statistics is taken of frequency of the designation of the desired scene and prior to the designation of the desired scene by the customer, a commemorative image is made available for each of the images of frequently designated scenes.

Preferably, the scene designating means designates the image of the desired scene utilizing a biological reaction occurring in the customer.

Preferably, the biological reaction is at least one parameter selected from among heartbeat, breathing, body temperature, brain waves and movement and attitude of eyeballs of the customer.

### BRIEF DESCRIPTION OF THE DRAWINGS

FIG. 1 is a block diagram outlining an embodiment of the system of the invention for offering commemorative images on the viewing of moving images by implementing the method of the invention for offering commemorative images on the viewing of moving images;

FIG. 2 is a flow chart showing an example of the flow of general processing in a first embodiment of the invention;

FIG. 3 is a flow chart showing an example of the flow of general processing in a second embodiment of the invention;

FIG. 4 is a flow chart showing an example of the flow of general processing in a third embodiment of the invention;

FIG. 5 is a flow chart showing an example of the flow of general processing in a fourth embodiment of the invention; and

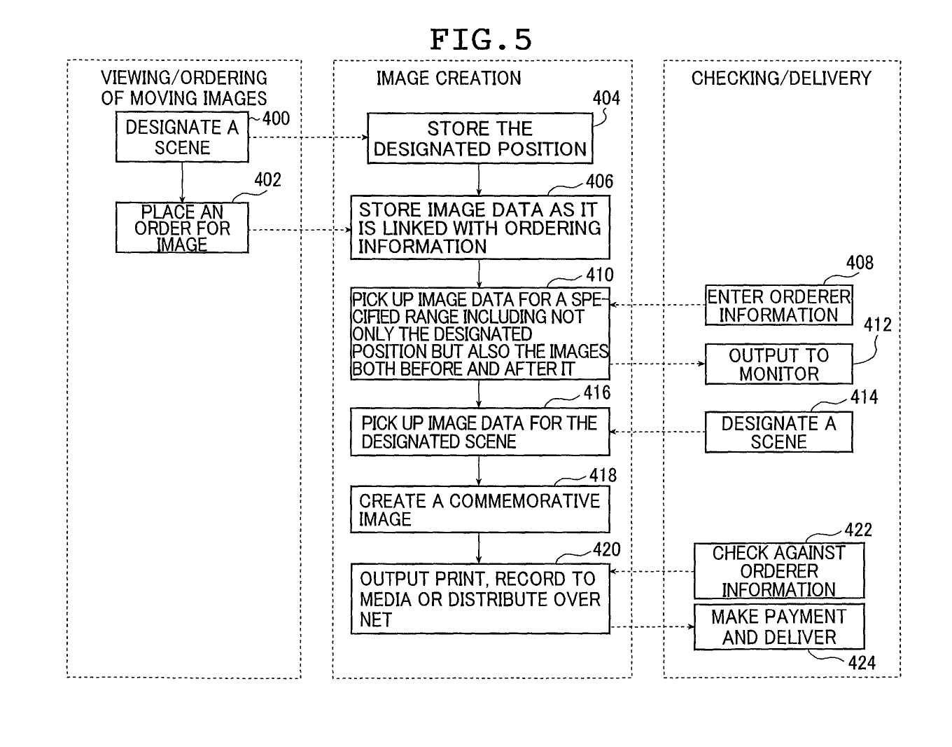

FIG. 6 is a flow chart showing an example of the flow of general processing in a fifth embodiment of the invention.

### DESCRIPTION OF THE PREFERRED EMBODIMENTS

The method and system of the invention for offering commemorative images on the viewing of moving images are described below in detail with reference to the preferred embodiments shown in the accompanying drawings.

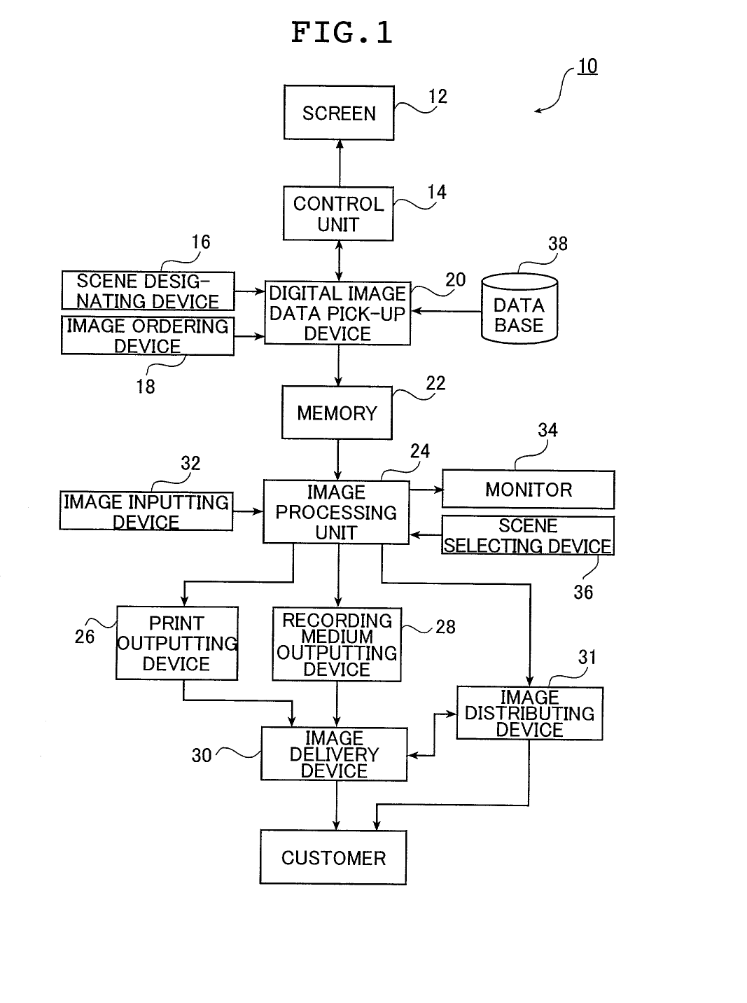

FIG. 1 is a block diagram outlining an embodiment of the system of the invention for offering commemorative images on the viewing of moving images by implementing the method of the invention for offering commemorative images on the viewing of moving images. FIG. 1 shows all functions in one chart that are used in each of the embodiments described below.

The system for offering commemorative images on the viewing of moving images which is indicated generally by 10 in FIG. 1 or the moving image print service system also generally indicated by 10 in FIG. 1 (whichever system is hereunder referred to simply as the “system”) is a system by which the image of a particular scene of a motion picture that is being presented at a movie theater and which is designated by a customer while he or she is viewing the motion picture is output as an image, typically as the print of a moving image, commemorative of the viewing of moving images and delivered to the customer.

The system 10 is generally divided into parts, one provided in the movie theater and the other in the apparatus for offering commemorative images on the viewing of moving images. The first part comprises a control unit 14 including a projector which presents the motion picture onto a screen 12 on the basis of digital image data, a scene designating device 16 for designating the image of a particular scene out of the motion picture being viewed by the customer, an image ordering device 18 for placing an order for an image, a digital image data pick-up device 20 for picking up digital image data corresponding to the image of the scene designated by the customer, and a memory 22 for storing the picked-up digital image data. The second part comprises an image processing unit 24 which applies specified image processing schemes to digital image data of interest to create an commemorative image on the viewing of moving images, an image outputting device including basic components such as a print outputting device 26 for outputting the created commemorative image as a print of moving image and a recording medium outputting device 28 for outputting the digital image data about the commemorative image to a specified recording medium, an image delivery device 30 for delivering the output print, the recording medium, etc. to the customer, and an image distributing device 31 which outputs the digital image data about the commemorative image as distribution data and distributes said data to the customer.

To begin with, the system 10 causes the control unit 14 to present a motion picture onto the screen 12 on the basis of digital image data. As already mentioned, the part of the system 14 which is provided in the movie theater has the scene designating device 16 which allows a customer to designate the image of a particular scene out of the motion picture he or she is viewing and the image ordering device 18 which places an order for the image.

The scene designating device 16 is not limited in any particular way; it may be a button or a key-operated panel that are provided on each customer's seat in the theater; alternatively, it may be a mobile information terminal or a remote control switch which are leased to customers when they are admitted into the theater. The scene designating device 16 may be of any type that permits the customer to transmit necessary information to the system 10. To permit manipulation by the customer while he or she is viewing the movie, the scene designating device 16 is desirably as simple as possible to operate.

In order to detect a scene that is impressive to the customer, the scene designating device 16 may be composed of a detecting means such as a bio-sensor that detects a biological reaction that occurs in the customer; the detected biological reaction is used as information that allows the customer to designate the image of the impressive scene. The biological reaction to be used may be at least one parameter selected from the heartbeat, breathing, body temperature, brain waves and the movement and attitude of eye balls and particular scenes may be designated in accordance with the intensity, the amount of change and other characteristics of these biological reactions.

The image ordering device 18 is a means by which orderer information which specifies the person who placed the order and image delivery information which designates the method of delivering the image (including, for example, the medium to be delivered, the place where delivery is made and the method of making payments) are transmitted to the system as image ordering information. As in the case of the above-mentioned scene designating device 16, the image ordering device 18 may be a button or the like that are provided on the customer's seat or a remote controller or the like that are leased to the customer. Preferably, the image ordering device 18 is an integral part of the scene designating device 16.

In addition to transmitting the scene designating information, orderer information and other necessary information to the system 10, the scene designating device 16 and the image ordering device 18 may record these items of information in a recording medium (memory card) such as a magnetic card so that the customer can use it at a later time to claim the delivery of the created commemorative image on the viewing of moving images.

As already mentioned, the system 10 has two other devices to be provided in the theater; they are the digital image data pick-up device 20 which, in response to the received signals from the scene designating device 16 and the image ordering device 18, accesses the control unit 14 and picks up digital image data that corresponds to the image of the scene designated by the customer, and the memory 22 which stores the picked-up digital image data, as well as the orderer information and the other items of information mentioned above.

As already mentioned, the part of the system 10 which is provided in the apparatus for offering commemorative images on the viewing of moving images comprises the image processing unit 24 which reads digital image data from the memory 22 provided at the theater and applies specified image processing schemes to create an commemorative image on the viewing of moving images, print outputting device 26 for outputting the created commemorative image as a print, recording medium outputting device 28 for outputting the digital image data about the created commemorative image to a specified recording medium and image delivery device 30 for delivering the output print, the recording medium and the like to the customer, as well as the image distributing device 31 which outputs the digital image data about the created commemorative image as distribution data and distributes it to the customer. Part of the image processing unit 24, print outputting device 26, recording medium outputting device 28 and image distributing device 31 constitutes an image outputting device. While the image distributing device 31 functions as an image outputting means which outputs the digital image data about the created commemorative image as distribution data, it also functions as an image delivery means since it is capable of distributing the output distribution data to the customer.

The other components of the system 10 are an image inputting device 32, a monitor 34, a scene selecting device 36 and a data base 38.

The customer may sometimes wants to synthesize the image of oneself with the image of a particular scene in the movie he or she is viewing. In this case, the image inputting device 32 is used to input such image of oneself. The image of the scene designated by the above-mentioned scene designating device 16 is displayed on the monitor 34 for verification purposes. Among the plurality of images of scenes that are displayed on the monitor 34, the scene selecting device 36 finally selects the image the customer really wants to order. The images of several scenes which customers are likely to order are chosen preliminarily from the movie and pre-stored in the data base 38; upon designation by a customer, the data base 38 is accessed and the image data for the image in the same or similar scene is picked up for subsequent use.

Various embodiments of the present invention are described below.

To begin with, a first embodiment of the invention is described. In the first embodiment, a customer viewing a motion picture (moving images) in a movie theater designates the image of a particular scene out of the picture he or she is viewing, whereupon among the video signals for the picture being presented by digital image signals, digital image data representing the image of the designated scene is picked up and a print reproducing the image of the designated scene or a recording medium to which the picked-up image data has been output is offered to the customer or image data reproducing the designated scene is offered as distribution data to the customer over a communication network such as the Internet.

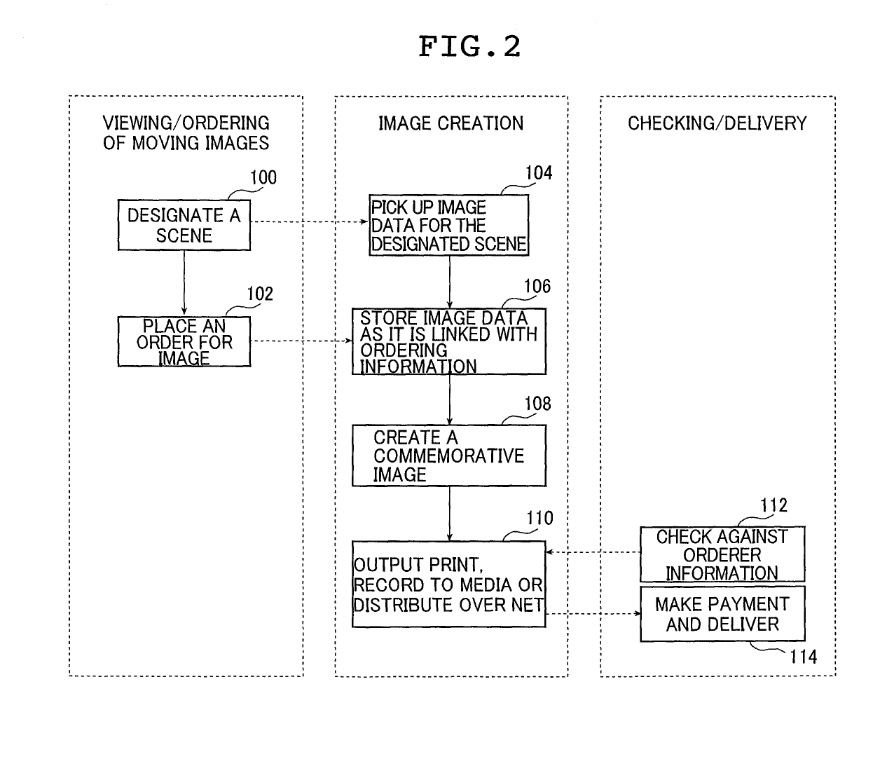

FIG. 2 shows the flow of general processing in the first embodiment of the invention as it is divided into two parts, the first part being the placement of an image by the customer and the second part consisting of image creation and checking/delivery and executed by the system.

In the first part, the customer designates the image of a particular scene he or she desires from among the scenes of the picture being presented and places an order for the image of the designated scene. Specifically, in step 100 in FIG. 2, the customer designates a scene by means of the scene designating device 16. As already mentioned, the scene designating device 16 is a means of communicating the customer's information to the system and is typically in the form of a button or an operating panel that are provided on each customer's seat in the theater or a remote controller leased to the customer. The scene designating device 16 is connected either by radio or over wires (cables) to the control unit 14 in the system 14.

In the next step 102, the customer places an order for the desired image by means of the image ordering device 18 which transmits to the system 10 the image ordering information which specifies the orderer information and the image delivery information. The image ordering device 18 is preferably an integral part of the scene designating device 16. The orderer INFORMATION is for specifying the person who placed an order for the particular image and it may be given by, for example, the seat number or the like or it may be contained in a customer ID under preliminary contract. The image delivery information (which is hereunder referred to simply as “delivery information”) contains a specific format in which the customer desires the image should be delivered, for example, a print, a collection of images such as one of photos (a print album) or one of moving images, a recording medium such as CD-R, DVD-R or MO, or a specific format in which the customer desires the image should be output, for example, printing in which the image is output to print paper, ink-jet sheet or plain paper, a format in which the image is recorded to a recording medium such as CD-R, DVD-R or MO, or a format in which the image is recorded to a server over a communication network such as the Internet (which is hereunder referred to as the “net”), i.e., distributed over the net. The delivery information preferably contains other items such as the place of delivery and the method of making payments of the fee.

Preferably, the orderer information and the delivery information are transmitted only once just before the movie starts and, thereafter, the customer as he or she is viewing the movie only operates the scene designating device 16 to designate the desired scene (by, for example, pressing the scene designating button), whereupon the scene designating information as well as the customer ID is transmitted so that scene designation also results in the placement of an order for the image.

Preliminary transmission of the orderer information and the delivery information is not the sole case of the invention and it is of course within the scope of the invention to place an order for the image by transmitting the orderer information and the delivery information together with the scene designating information each time a scene is designated. In the embodiment under consideration, the orderer information and the delivery information are transmitted together before or at the time of scene designation; the invention is not limited to this particular case and, instead, only the orderer information may be transmitted before or at the time of scene designation or at the time when an order for the image is placed whereas the delivery information is transmitted at a suitable time after the placement of an order (or scene designation) but before the delivery of the image. In other words, the delivery information may be used not by the image ordering device 18 but by the image delivery device 30.

The scene designating information and the image ordering information consisting of the orderer information and the delivery information are sent to the digital image data pick-up device 20. In step 104, the digital image data pick-up device 20, having received the scene designating information, picks up the image data from the control unit 14 which represents the designated scene. The scene designating information is not limited in any particular way but may be the time at which the scene designating device 16 was operated.

In the next step 106, the digital image data picked up from the control unit 14 is recorded in the memory 22 together with the orderer information and the delivery information by means of the digital image data pick-up device 20. The memory 22 stores the digital image data as it is linked with the orderer information and the delivery information.

In the next step 108, the image processing unit 24 reads the digital image data from the memory 22 and applies specified image processing schemes to create an commemorative image on the viewing of moving images. If “delivery as a print” has been designated by the delivery information, the image processing unit 24 performs not only the various image processing schemes but also the image processing (image data transformation) required to generate image data for prints. If “outputting to a recording medium and creating an image file” has been designated, the image processing unit 24 also performs the image processing required to generate image data for an image file. If netted distribution has been designated by the delivery information, the image processing unit 24 also performs the image processing required to generate distribution data for distribution over the net.

In the next step 110, the commemorative image on the viewing of moving images is output from the print outputting device 26 if print delivery has been designated whereas the commemorative image is output from the recording medium outputting device 28 if the creating an image file has been designated. If netted distribution has been designated, distribution data for the commemorative image is generated and output, for example, to a server over the net by means of the image distributing device 31. In the case of prints, individual photographic prints (prints of moving images) may be offered to the customer but they are preferably rearranged in layout and offered as a collection of photos because this provides the benefit of scale merit; in addition, unlike leaflets that are already prepared and sold by the theater, such a collection of photos has been compiled to the preference of the customer and, hence, meets the requirement of customer satisfaction. In this respect, the method under consideration can offer photographs that differ from conventional movie stars' portraits. As in the case of prints, images are preferably compiled to make a collection and stored in a recording medium or distributed over the net.

Finally, in step 112, the image delivery device 30 checks the created commemorative image against the orderer information and in step 114, the commemorative image (a print of moving image, recording medium or netted distribution data) is delivered to the customer in exchange for the payment of the fee.

The image delivery means 30 typically has a reader and an operating portion in the form of a touch panel; the reader reads the image ordering information from the recording medium or magnetic card (e.g. customer's ID card or credit card) to which the image ordering information has been recorded by means of the image ordering device 18 (or the scene designating device 16). The customer operates the operating portion in accordance with the instructions given by the image delivery device 30, whereupon the commemorative image is checked against the orderer information and delivered to the customer.

If the recording medium such as an ID card to which the image ordering information has been recorded is set in the reader of the image delivery device 30 by the customer in step 112, the image delivery device 30 reads the orderer information from the recording medium and checks it against the information attached to the commemorative image. If the image is verified to be such that the order for it was placed by the right person, the process goes to step 114, where payment of the fee is made and the image is delivered to the customer. If verification is made, the method of making payments is displayed on the touch panel which is operated by the customer to designate his or her method of making payments; by further operating the touch panel in accordance with the instructions from the apparatus, prints or the recording medium to which the image data have been recorded are ejected from the image delivery device 30 through a product delivery slot and delivered to the customer. To make payment of the fee, the customer may deposit cash into the apparatus or insert his or her credit card for subsequent withdrawal from his or her bank account.

The image delivery means 30 may desirably be installed at the entrance and exit of the movie theater so that the customer can receive the commemorative image when he or she leaves the theater. However, this is not the sole method of image delivery and various other methods may be adopted; for example, instead of such automatic delivery by the apparatus, the customer may show to the clerk at the reception counter the stub of the admission ticket indicating the orderer information and the delivery information and then the clerk makes the necessary checking and verification before delivering the image to the customer. Alternatively, the customer may some other day goes to a laboratory, a convenience store or other settings under contract with the theater, show the recording medium, ID card or the like to which the image ordering information has been recorded, and have the image delivered. Yet another method is for the customer to enter his or her address or the like when inputting the delivery information and to have the image mailed to his or her house some other day.

In the case of netted distribution, the image distributing device 31 checks the orderer information about the customer, customer's ID or the like, verifies the payment (of the fee) and the method of making payments (e.g. withdrawal by credit card, transfer to bank account, or the aforementioned deposit of cash into the image delivering device 30), and then distributes to the customer the distribution data for his or her commemorative image of interest. For instance, the image distributing device 31 may transmit the distribution data for the commemorative image to the customer's server; alternatively, the image distributing device 31 may get the customer to access it using the orderer information, customer ID or the like and, after verifying the orderer information, customer ID, the fact of payment, etc., permits customer's access to the image distributing server so that the distribution data for the commemorative image of interest is downloaded to the customer from the image distributing server.

We next describe a second embodiment of the invention.

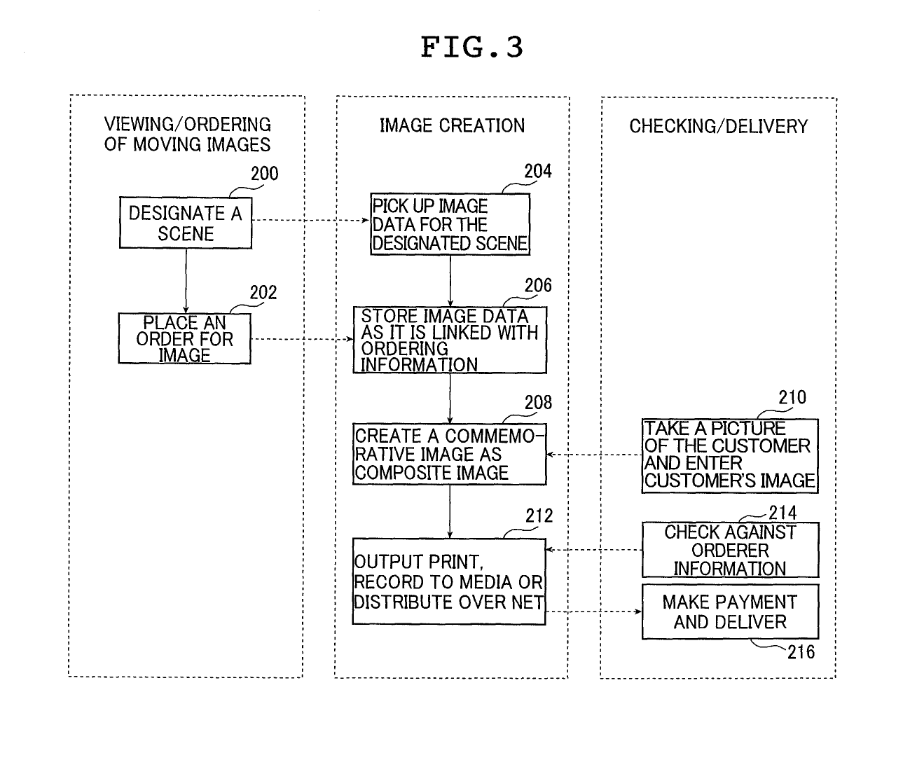

As in FIG. 2, the flow of general processing in the second embodiment is shown in one chart in FIG. 3. As is clear from FIG. 3, the second embodiment is similar to the first embodiment in that the image of a particular scene out of a movie is designated by the customer who is viewing the movie and offered to the customer as an commemorative image on the viewing of moving images. The difference is that in the second embodiment, the commemorative image on the viewing of moving images is created by compositing the image of a particular scene in the movie with the customer's image. Hence, the following description principally concerns this difference.

Referring to FIG. 3, step 200 (scene designation), step 202 (placement of an order for image), step 204 (picking up the image data for the designated scene) and step 206 (storing the image data as it is linked with the orderer information and the delivery information) are the same as in the first embodiment.

In the next step 208, the image of the customer designated scene is composited with the customer's image as an commemorative image on the viewing of moving images is created from the image data associated with the first-mentioned image. To this end, the image input device 32 such as a digital camera is used to take a picture of the customer and the customer's image is input in step 210. In step 208, the image processing unit 24 uses the input image of the customer and composites it with the aforementioned image about the designated scene to create an commemorative image on the viewing of moving images.

The customer's image can be input at various times such as, for example, when the customer returns the leased remote controller to the theater after the end of the movie, when the recording medium such as an ID card to which the image ordering information has been recorded is inserted into the image delivery device 30 or when the stub of the admission ticket is shown at the delivery counter; if, on any one of these occasions, the customer so requests, the image input device 32 may take a picture of the customer and capture the image. Alternatively, the image input device 32 may be a scanner and the image the customer already brought into the theater may be input by being read with the scanner. In the case of netted distribution, the image input device 32 may be information equipment such as a customer's computer (PC) or PAD and the customer's image data captured into such information equipment may be input by accessing the image processing unit 24 in the system 10.

The customer's image is input together with the orderer information which specifies the customer and is then composited into a specified image on the basis of the orderer information. If the product to be finally output is a collection of photos, the customer's image may be composited in one of two ways; it is placed separate from the image of the designated scene by being positioned appropriately in a blank portion or, alternatively, it is placed as an inset within the image of the designated scene.

In the case described above, the creation of an commemorative image on the viewing of moving images is effected after the end of the movie if the customer wants image compositing and inputs his or her image. However, this is not the sole case of the invention and while the movie is being presented, a print may be prepared each time the customer designates a particular scene out of the movie and places an order for the image of that scene; in this alternative case, prints having no customer's image composited with the designated scenes are output and delivered to the customer who then compares those prints and chooses one or more prints that need compositing of the customer's image and places an order for composite prints. The image to be composited is not limited to the image of the customer immediately before or after the viewing of the movie and any image that is favored by the customer as well as images that are related to the customer may be composited.

Step 212 [print output or media recording (output to recording medium) or netted distribution], step 214 (checking against orderer information) and step 216 (making payment and delivery) are also the same as in the first embodiment.

Thus, in the second embodiment, the customer can have a print in which a scene out of a movie he or she likes is composited with his or her own image and the print is a leaflet solely belonging to the customer. This further increases the added value of the commemorative image, thereby increasing the joy of photographs.

We next describe a third embodiment of the invention.

In the third embodiment, still images or a group of (non-continuous) still images are not output as in the foregoing embodiments but moving images or a group of continuous still images are output and offered as a collection of short highlight scenes (a collection of images) that have been prepared by extracting portions of one action that impressed the customer.

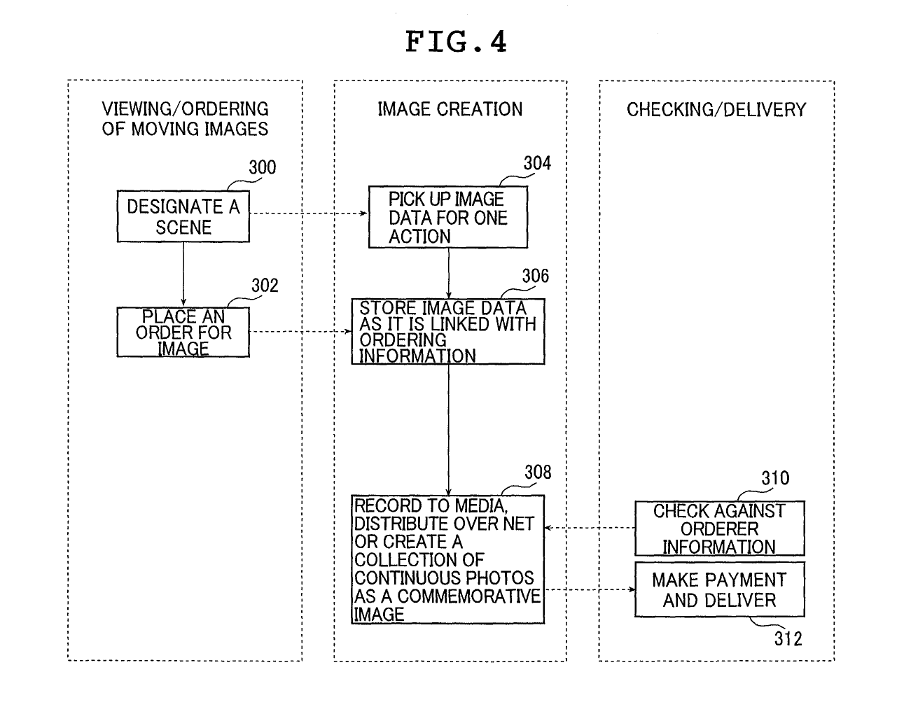

The flow of general processing in the third embodiment is shown in FIG. 4.

As FIG. 4 shows, the flow of the basic processing in the third embodiment is the same as in the first embodiment shown in FIG. 2. The difference is that in the third embodiment, if the customer designates a particular scene, the image data for the designated scene is not output but moving images or a group of continuous still images are output to represent one action including the designated scene.

In FIG. 4, step 300 (scene designation) and step 302 (placement of an order for image) are the same as in the foregoing first embodiment.

In step 304, the scenes of moving images of one action including the designated scene are picked up from the control unit 14 by means of the digital image data pick-up device 20. Specified time ranges may be preset for such scenes of moving images of one action by the system or, alternatively, those scenes may be picked up by automatic detection of the scene

changes. If desired, the customer may have an option for designating the range of such scenes of moving images of one action.

In step 306, the picked-up scenes of moving images of one action are stored in the memory 22 as they are linked with the orderer information.

In step 308, the scenes of moving images of one action stored in the memory 22 are subjected to specified image processing schemes and recorded to a specified medium (recording medium) as commemorative images on the viewing of moving images. The specified medium is what the customer designates in the delivery information and may be exemplified by recording media including video tape, CD-R, DVD-R and MO.

As in the foregoing embodiments, the scenes of moving images of one action may be distributed over a net or may be offered as a collection of continuous still images (a collection of continuous photographs) such as a collection of chronophotographs.

Step 310 (checking against orderer information) and step 312 (making payment and delivery) are also the same as in the first embodiment.

Thus, in the third embodiment, among various scenes of the movie being presented, the customer designates a particular scene as a favorite one and the scenes of moving images of one action including the designated scene are recorded to a recording medium such as video tape, CD-R, DVD/R or MO or distributed over a net or compiled into a collection of chronophotographs (a collection of continuous photographs) and offered to the customer. In either way, the customer can have a collection of short highlight scenes to his or her preference and enjoy them at home by simple procedures of playback.

We next describe a fourth embodiment of the invention.

In the fourth embodiment, the customer temporarily designates a scene out of the motion picture being presented and, at a later time, displays on the monitor a specified range of images including the designated scene, chooses a particular scene from those images and designates it as the scene for which an order to print is finally to be placed.

Step 400 (scene designation) and step 402 [placing an order for image (inputting orderer information)] are the same as in the first embodiment.

In step 404, only the positions of the designated scenes are stored in the memory 22. In step 406, the orderer information is also stored in the memory 22 as it is linked with the positions of the designated scenes.

After the end of the movie, the customer operates the monitor 34 and the scene selecting device 36 that may typically be installed in the movie theater and chooses the image of the scene for which an order to print is finally to be placed. In step 408, the customer enters the orderer information using a recording medium such as an ID card to which the orderer information has been recorded or by means of operating the scene selecting device 36 in the form of a manipulating system comprising a keyboard, a mouse, etc. Then, in step 410, image data for a specified range of images including images both before and after the designated scene are picked up (output) from the control unit 14; in step 412, the picked-up image data are displayed on the monitor 34.

In step 414, the customer looks at the displayed images on the monitor 22 and operates the scene selecting device 36 to designate the scene for which an order to print is finally to be placed. Thereafter, the image data for the designated scene are picked up in step 416; the picked-up image data are subjected to specified image processing schemes in step 418 to create an commemorative image on the viewing of moving images. In step 420, the commemorative image created in step 418 is output to a print or recorded in media or distributed over a net according to the customer-designated delivery information.

Step 422 (checking with the orderer information) and step 424 (making payment and delivery) are also the same as in the first embodiment.

Thus, in the fourth embodiment, a specified range of images including not only the customer-designated scene but also the images both before and after it are displayed on the monitor so that the customer can choose the best desirable scene from the displayed images by making the second scene designation.

The scene initially designated by the customer is not always the best because the person in it may have closed the eyes. The fourth embodiment is effectively adopted in a case like this.

In the case described above, the customer makes the second scene designation while looking at the monitor display. If desired, the apparatus may be so adapted that the image of a scene that is close to the initial customer-designated scene and which has high enough quality to show no blurs or shakes when picked up as a still image can automatically be selected from a specified range of images.

If, in either one of these cases (i.e., the customer makes the second scene designation looking at the monitor display or the apparatus automatically selects the designated scene from a specified range of images), no best image that corresponds to the designated scene is found within the specified range of images, the range may be further expanded or it may be shifted so that scene designation is performed by searching through the new range to find the best image.

As in the first embodiment, the customer may designate a particular scene and receive a print which reproduces the designated scene. In this case, once the scene is designated, the customer leaves everything to be done by the system and just waits for the delivery of the print. Alternatively, the system may be so adapted that before print delivery, the customer can make another monitor check of the image of the scene for which an order to print was placed by the customer.

In the fourth embodiment, rechecking of the designated scene by the customer may be done not only before outputting still images on a print and the like but also before outputting moving images as in the foregoing third embodiment.

We next describe a fifth embodiment of the invention.

In the fifth embodiment, the images of scenes out of the movie are preliminarily stored in a data base and in response to customer's scene designation, a scene which is the closest to the designated scene is chosen from the data base and put to subsequent use.

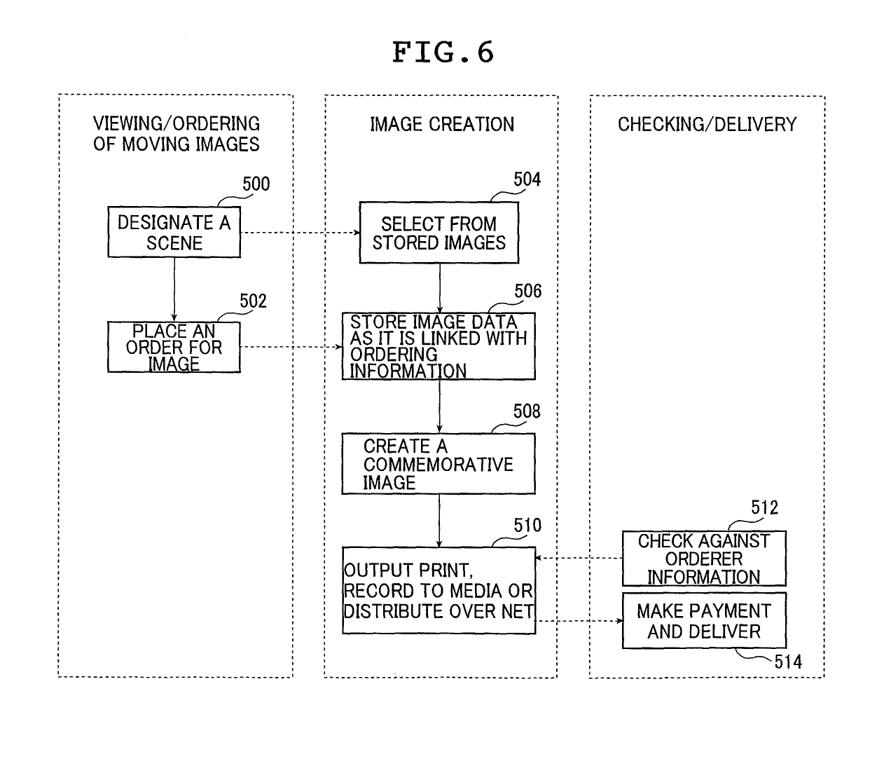

The flow of general processing in the fifth embodiment is shown in FIG. 6.

As FIG. 6 shows, the flow of processing in the fifth embodiment is essentially the same as in the first embodiment; the difference is that in step 504, the digital image data pick-up device 20 does not pick up the image of a customer-designated scene from the video signals via the control unit 14 but a scene which is the closest to the customer-designated scene is chosen from the images of the scenes preliminarily stored in the database 38. Other aspects of the fifth embodiment, namely, step 500 (scene designation), step 502 (placing an order for image), step 506 (storing image data as it is linked with the orderer information and the delivery information), step 508 (creating an commemorative image on the viewing of moving images), step 510 (outputting the commemorative image on a print, outputting it to a recording medium or distributing it over a net), step 512 (checking with the orderer information) and step 514 (making payment and delivery), are the same as the counterparts in the first embodiment.

Thus, in the fifth embodiment, the images of scenes that will be commemorative of the viewing of moving images are already made available, so a high-quality image of the best scene can be offered as a commemorative image. Conventionally, when motion pictures are shot, still photographs of good quality that are free from blurs and shakes are also taken and posted as a medium of advertising the movie or sold at movie theaters and the like as movie stars' portraits. This is just similar to the case realized by the fifth embodiment; the image of a scene that is substantially equivalent to the image of the scene the customer designates from moving images is already made available as a high-quality image that is free from blurs and shakes and a commemorative image of good enough quality can be offered to the customer.

By thusly making the images of scenes in a movie already available, the present invention can be applied not only to the case of presenting movies based on digital image data but also to the conventional case of presenting film-based movies. Another advantage of making available the commemorative images on the viewing of moving images is that the image to be offered and its scope can be specified to define clearly the relationship between that image and copy right; this is also effective in price setting.

As for the scenes in moving images such as a motion picture, the image of the very scene that is actually designated by the customer need not be offered as a commemorative image. As long as high image quality is assured, one of a series of images that is either before or after the designated image and which can be regarded substantially equivalent to it will serve the purpose. Speaking particularly of scenes full of motion, it is desired to choose a scene that shows only limited blurs or shakes when it is picked up as a still image. Therefore, as long as they are associated with the scenes in moving images, the images to be made already available may be like the conventional movie stars' portraits taken with a still camera.

Turning back to the third embodiment, it is not still images but scenes in moving images of one action that are output. The concept of the fifth embodiment can also be applied to this situation and moving images of one action may already be made available for each specified range of a movie. In this case, in accordance with the range of scenes designated by the customer, one sequence of moving images of one action that features a maximum overlap with the designated range of scenes is chosen from the already available list. The selected sequence of moving images of one action are output to a recording medium such as CD-R and used to prepare a collection of short highlight scenes in commemoration of the viewing of moving images.

Speaking further of the case of preparing a collection of moving images of one action, two scenes interposed by a clear change in the tone of sound often represent a development of scenes, so a collection of short moving images for one action may be prepared on each occasion such a clear change in sound tone occurs.

In the foregoing embodiments, the digital image data picked up from the control unit 14 by means of the digital image data pick-up device 20 are stored temporarily in the memory 22 together with the orderer information and the delivery information and then read out of the memory by means of the image processing unit 24 which applies specified image processing schemes to the digital image data to create an commemorative image on the viewing of moving images. The present invention is by no means limited to this particular case and the digital image data picked up by means of the digital image data pick-up device 20 may be directly transmitted to the image processing unit 24 which then applies specified image processing schemes to the digital image data to create an commemorative image on the viewing of moving images.

In the foregoing embodiments, it is preferred to collect statistics of the frequency of scene designation and as for the images of frequently designated scenes, for example, popular scenes in which popular movie stars or cartoon characters appear, commemorative images on the viewing of moving images, especially prints of those moving images, recording media to which the relevant image data have been recorded, netted distribution data, etc. are preferably made available prior to customer's scene designation.

In this way, commemorative images can be delivered to customers without keeping them waiting long after the end of the movie.

In each of the foregoing embodiments, the customer while viewing a motion picture in a theater designates a particular scene and places an order for an commemorative image on the viewing of moving images. The present invention is by no means limited to this particular case and it is also applicable to the case of presenting a movie in aircraft; in this case, the offered image is commemorative of not only the viewing of moving images but also the travel if the date, the flight number, the destination and other information are recorded on the commemorative image. If appropriate, only the orderer information may be recorded on a specified recording medium during the flight so that some other day the customer brings the recording medium to a specified image delivery station to get the commemorative image. Alternatively, the customer who is placing an order for image during the flight designates the address of the recipient of the image so that it can be received some other day by mail or any other suitable means.

The motion picture and other moving images to be viewed are not limited to the above-described case of presentation based on digital image data; they also include cine-film based images, as well as video images that are formed on the basis of image signals from accumulated images stored in recording media such as video tape and video disk or solid storage means such as IC memory. The images to be viewed may be projected onto a screen or they may be represented by direct formation on a display means.

In yet another possible embodiment, the customer who is watching a video or a TV program may designate an image he or she likes and access the image supplier via a communication network such as the Internet to place an order for the designated image. In this case, the commemorative image may be received as print or recorded in a suitable medium such as CD-R. Alternatively, the customer may have the image data distributed via the Internet so that a printout is obtained from the customer's printer.

In the present invention, the moving images in commemoration of which an image is to be created are not limited to the aforementioned motion picture, video and TV program and they also include a representation of moving images by a succession of still images, as well as a sequence of varying scenes. Other examples include sightseeing and event videos that show sequences of varying landscape and objects. The moving images under consideration need not have the continuity of motion pictures.

While the method and system of the invention for offering an commemorative image on the viewing of moving images have been described above in detail with reference to various embodiments, it should be understood that the invention is by no means limited to those examples and various improvements and modifications can be made without departing from the scope and spirit of the invention.

As described on the foregoing pages, according to the present invention, the images of scenes chosen by a customer as he or she is viewing a motion picture, video or TV program are offered to the customer as high-quality commemorative images on the viewing of the moving images by being output as prints, a collection of photographs or a collection of short moving images, or being output as a specified recording medium having the relevant image data recorded thereto, or by distributing said relevant image data via a network.

What is claimed is:

1. A method of offering a commemorative image on viewing of moving images, comprising the steps of:
allowing a customer who is viewing moving images to designate an image of a desired scene out of the moving images and also allowing the customer to place an order for said image of the thus designated scene as accompanied by orderer information which specifies said customer;
picking up first digital image data from video signals for said moving images in response to the designation of said desired scene, said first digital image data corresponding to the image of said designated scene;
creating the commemorative image, using the picked-up first digital image data, that is commemorative or the viewing of the moving images and reproduces the image of said designated scene; and
delivering the created commemorative image to said customer after checking it against said orderer information.

2. The method according to claim 1, further comprising the steps of:
storing in a specified memory said first digital image data as picked up from the video signals for said moving images; and
reading said stored first digital image data out of said specified memory,
said commemorative image being created using said first digital image data as read out of said specified memory.

3. The method according to claim 1, wherein said commemorative image is created as second digital image data from said first digital image data, and output as a print or prints of the moving images that reproduces said commemorative image from said second digital image data or output as a recording medium or media having said second digital image data recorded thereto or created as distribution data from said second digital image data which is to be distributed via a communication network.

4. The method according to claim 3, wherein the delivery of said commemorative image takes form of delivering said output print or prints of the moving images or said output recording medium or media to said customer or distributing said distribution data to said customer via said communication network.

5. The method according claim 1, wherein said commemorative image is delivered to said customer in accordance with an image delivery method designated by said customer.

6. The method according to claim 5, wherein image delivery information that designates said image delivery method is sent with said orderer information when the order for the image of said designated scene is placed by said customer.

7. The method according to claims 1, wherein said commemorative image is created as a collection of images of a plurality of designated scenes.

8. The method according to claim 7, wherein said collection is an album prepared in a specified format using a plurality of prints of moving images that reproduce said plurality of designated scenes.

9. The method according to claim 1, wherein said first digital image data which is picked up from the video signals for said moving images in response to said designation of the desired scene when the order for said image has been placed is said first digital image data for a plurality of successive images in one action which corresponds to said designated scene, second digital image data for said one action is created as said commemorative image from said first digital image data for one action, and said second digital image data for said one action is recorded to a specified recording medium as said commemorative image.

10. The method according to claims 1, wherein said first digital image data is composited with an image already prepared by said customer to create said commemorative image.

11. The method according to claim 2, wherein said first digital image data for images of designated scenes by said customer are stored in said memory, said first digital image data are read out of said memory and displayed on a monitor, and the image of said designated scene by said customer, for which the order is finally to be placed by the customer is chosen from the thus displayed images of designated scenes by said customer on the monitor.

12. The method according to claim 2, wherein said first digital image data for the images of scenes within a specified time range including not only the image of said designated scene out of said moving images which has been designated by said customer but also images both before and after said image are stored in said memory, said first digital image data are displayed on a monitor, and the image of said designated scene by said customer, for which the order is finally to be placed by the customer is designated from the thus displayed images of the scenes within said specified time range on the monitor.

13. The method according to claim 1, wherein said first digital image data corresponding to images of a plurality of specified scenes within said moving images are preliminarily stored and when the order for the image of said designated scene is placed, the first digital image data for the image of a scene which is the closest to the image of said designated scene is picked up from said preliminarily stored first digital image data in response to said designation of the desired scene.

14. The method according to claim 1, wherein statistics is taken of frequency of said designation of the desired scene and prior to designation of the desired scene by said customer, a commemorative image is made available for each of the images of frequently designated scenes.

15. The method according to claims 1, wherein a biological reaction occurring in said customer is utilized to designate the image of said desired scene.

16. The method according to claim 15, wherein said biological reaction is at least one parameter selected from among heartbeat, breathing, body temperature, brain waves and movement and attitude of eyeballs of said customer.

17. A system for offering a commemorative image on viewing of moving images, comprising:
a scene designating device by means of which a customer who is viewing moving images designates an image of a desired scene out of the moving images;
an image ordering device by means of which the customer places an order for creation of the image of said designated scene with scene designating information which identifies the image of the designated scene and orderer information which specifies said customer;
a digital image data pick-up device for picking up first digital image data from the video signals for said moving images in response to the scene designation, said first digital image data corresponding to the image of said designated scene;
an image output device which, using the first digital data as picked up by said digital image data pick-up device, creates a commemorative image that is commemorative on the viewing of the moving images and reproduces the image of said designated scene and outputs said commemorative image; and
an image delivery device which delivers said output commemorative image to said customer after checking it against said orderer information.

18. The system according to claim 17, further comprising a memory for storing the first digital image data as picked up by said digital image data pick-up device, wherein said image output device creates said commemorative image using said first digital image data as read out of said memory.

19. The system according to claim 17, wherein said image output device creates said commemorative image as second digital image data from said first digital image data, and it is at least one device selected from among a print output device which outputs a print or prints of the moving images that reproduces said commemorative image from said second digital image data, a recording medium output device which outputs a recording medium or media having said second digital image data recorded thereto, and an image distributing device which creates distribution data from said second digital image data and distributes it via a communication network.

20. The system according to claim 19, wherein said image delivery device is such that said print or prints of the moving images as output from said print output device or said recording medium or media as output from said recording medium output device is delivered to said customer as said commemorative image or said distribution data is distributed to said customer via said communication network by means of said image distributing device.

21. The system according to claim 17, wherein said image delivery device delivers said commemorative image to said customer in accordance with an image delivery method designated by said customer.

22. The system according to claim 21, wherein image delivery information that designates said image delivery method is sent with said orderer information when the order for the image of said designated scene is placed by said customer.

23. The system according to claim 17, wherein said image output device creates said commemorative image as a collection of images of a plurality of designated scenes.

24. The system according to claim 18, wherein said digital image data pick-up device picks up said first digital image data for a plurality of successive images in one action which corresponds to said designated scene and stores the picked-up first digital image data in said memory, and said image output device creates as said commemorative image second digital image data from said first digital image data for said one action which has been stored in said memory and outputs said second digital image data for a one action to a specified recording medium.

25. The system according to claim 17, further comprising:
an image input device for entering an image already prepared by the customer; and
an image compositing device by means of which the image entered by said image input device is composited with said first digital image data, wherein
a composite image created by said image compositing device is output from said image output device as said commemorative image.

26. The system according to claim 18, further comprising:
a monitor by means of which said first digital image data as stored in said memory which correspond to images of designated scenes by said customer are read out of said memory and displayed; and
a scene selecting device by means of which the image of said designated scene by customer, for which the order is finally to be placed by the customer is chosen from the thus displayed images of said designated scenes by customer on the monitor.

27. The system according to claim 26, wherein said digital image data pick-up device picks up said first digital image data for the images of scenes within a specified time range including not only the image of said designated scene out of said moving images which has been designated by said customer but also images both before and after said image and stores said first digital image data in said memory, said first digital image data are displayed on said monitor, and the image of said designated scene by said customer, for which the order is finally to be placed by the customer is designated by said scene selecting device from the thus displayed images of the scenes within said specified time range on the monitor.

28. The system according to claim 17, further comprising a data base for preliminarily storing said first digital image data corresponding to images of a plurality of specified scenes within said moving images, wherein said digital image data pick-up device picks up from said data base the first digital image data for the image of a scene which is the closest to the image of said designated scene by said customer.

29. The system according to claim 17, wherein statistics is taken of frequency of said designation of the desired scene and prior to said designation of the desired scene by said customer, a commemorative image is made available for each of the images of frequently designated scenes.

30. The system according to claim 17, wherein said scene designating means designates the image of said desired scene utilizing a biological reaction occurring in said customer.

31. The system according to claim 30, wherein said biological reaction is at least one parameter selected from among heartbeat, breathing, body temperature, brain waves and movement and attitude of eyeballs of said customer.
